(19) United States
(12) Patent Application Publication
(10) Pub. No.: US 2026/0291420 A1
(43) Pub. Date: Sep. 24, 2026

(54) CONTROL OF THE STATOR CURRENT OR THE CONCATENATED STATOR FLUX FOR OPERATING A SYNCHRONOUS MACHINE WITH PERMANENT-MAGNET EXCITATION, AND METHOD

(71) Applicant: MAGNA Powertrain GmbH & Co KG, Lannach (AT)

(72) Inventor: Bernd Kolar, Pucking (AT)

(21) Appl. No.: 19/476,445

(22) PCT Filed: Apr. 11, 2024
(86) PCT No.: PCT/EP2024/059893

§ 371 Date: Oct. 17, 2025

(30) Foreign Application Priority Data
Apr. 20, 2023 (DE) 10 2023 203 654.1

(51) Int. Cl. H02P 21/28

(52) U.S. Cl. CPC H02P 21/28

(57) ABSTRACT

A method for controlling the stator current or the concatenated stator flux for operating a synchronous machine with permanent-magnet excitation using a controller includes performing robust exact linearization by a nonlinear control law such that the controlled nonlinear PMSM acquires the behavior of a linear PMSM.

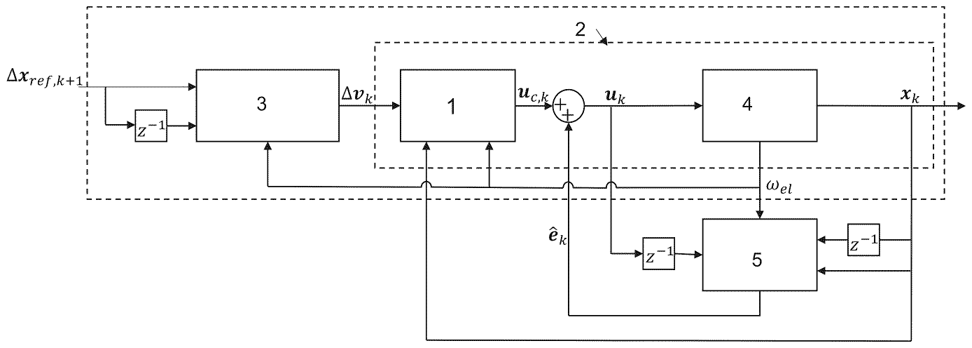

### CROSS REFERENCE TO RELATED APPLICATIONS

This application is a National Stage of International Application No. PCT/EP2024/059893, filed Apr. 11, 2024, which claims priority to DE 10 2023 203 654.1, filed Apr. 20, 2023. The entire disclosures of each of the above applications are incorporated herein by reference.

### FIELD

The invention relates to regulation of the stator current or the concatenated stator flux for operating a permanent-magnet synchronous machine.

The invention also relates to a method for regulating the stator current or the concatenated stator flux for operating a permanent-magnet synchronous machine.

### BACKGROUND

This section provides information related to the present disclosure which is not necessarily prior art.

Modern drive technology mainly uses two types of three-phase machines: asynchronous machines and synchronous machines. These electric motors are operated either on the rigid three-phase grid or in a regulated manner on the converter. With the aid of modern microprocessors, precise current detection and rapid power electronics, there are extensive possibilities for regulating torque and rotation rate of three-phase machines.

The synchronous machine is frequently used in robotics and in positioning-related tasks and also as generator in the production of energy. The advantages of a permanent-magnet synchronous machine (PMSM) lie inter alia in high power density, very good efficiency and a high attainable dynamic. These properties make them attractive in particular also for use in the automotive sector.

A cascaded regulation structure with lower-level (stator) current regulation is generally used in the regulation of a permanent-magnet synchronous machine. In this case, the current regulation typically takes place in rotor-fixed coordinates (d/q coordinate system), and the task consists in tracking the two independent current components along intended trajectories specified by the torque regulation. As an alternative to regulating the stator current, the concatenated stator flux can also be regulated, since the stator current and the concatenated stator flux are linked to one another by a (non-linear) coordinate transformation in a reversibly unambiguous manner.

Due to the simple structure and the possibility of calculating the regulator parameters by means of simple dimensioning rules, PI regulators are frequently used for stator current regulation.

Since a PI regulator involves a linear regulation concept, however, it is difficult to take the non-linearities of the system cleanly into account in the regulator design.

Therefore, only a limited dynamic tracking performance can also be achieved with a PI regulator. When there are rapid changes in the intended currents, the PI regulator leads to overshooting and generally to undesired oscillations.

The PI regulating circuit can even become unstable at higher rotation rates if the sampling frequency is selected too low. These effects are further intensified if the actual motor parameters deviate from the nominal parameters used for the regulator design.

Regulation is known from WO 2018 089 581 A1, which includes estimation of the position and the speed of a synchronous motor in an estimation unit before the motor is started. A controller controls a permanent-magnet synchronous motor using a field-oriented control-vector control routine that comprises a speed-proportional (PI) regulation loop, a field-weakening controller, a current PI regulation loop and a speed monitor.

Estimating the speed and/or position prior to the motor starting improves the control of synchronous motors, without sensors having to be used to measure position and speed.

Better dynamic tracking performance could be achieved, in principle, by flatness-based sequence regulation. The term “flatness-based regulation” here means that, in at least one step in the design of the regulation algorithm, the explicit algebraic relationship between the state variables and input variables of the system on the one hand and the components of a flat output and a series of their time derivatives on the other hand was used. In the case of the permanent-magnet synchronous machine, flatness-based regulation is particularly simple, since a flat output is given directly by the state variables (e.g. optionally stator currents or concatenated stator fluxes) and moreover they are precisely the variables to be regulated.

In practice, however, conventional flatness-based sequence regulation in PMSM motors leads to a very aggressive regulator due to the decoupling into two independent sequence-error systems for the two current components which is usually carried out in this case. In a time-discrete implementation, even a “dead-beat” regulator is produced. Due to the unavoidable measurement noise, the price for the better dynamic tracking performance would thus be a greater current ripple in the settled state.

DE 10 2021 104 242 A1 describes that non-linear effects, such as a temperature deviation e.g., can lead to imbalances between the resistance values of the three phases. The document is based on a linear model, which can be seen in the use of transmission functions. There is a transmission function only for linear systems, because they require the superposition principle; such a consideration in the frequency domain is not possible for non-linear systems. In the document, only the three phases are considered separately, with the aim of being able to map, and subsequently to compensate, imbalances in the parameters.

In EP 2 626 998 A1, a PI regulator is used for the current regulation and the system is considered to be linear.

It is the object of the invention to apply a suitable non-linear regulation method for a PMSM machine taking into account the generally non-linear connection between the stator currents and the concatenated stator fluxes.

### SUMMARY

This section provides a general summary of the disclosure, and is not a comprehensive disclosure of its full scope or all of its features.

The object is achieved with regulation of the stator current or the concatenated stator flux for operating a permanent-magnet synchronous machine, which represents a non-linear system, having at least one control unit that contains software modules, a non-linear regulator for robust exact linearization of the system, feed-forward control and a disturbance estimator.

The object is also achieved with a method for regulating the stator current or the concatenated stator flux for operating a permanent-magnet synchronous machine having regulation, wherein exact linearization of the PMSM in accordance with the concept of robust exact linearization with a non-linear regulation law of the form u=φ(x,Δv) takes place in such a way that the originally non-linear PMSM \dot{x}=f(x,u) acquires the behavior of a linear PMSM.

The robust exact linearization is applied to a time-discretized model that takes the sampling time into account, and thus leads to a linear, time-discrete system. In fact, especially in non-linear systems, the significantly more common variant is to derive the regulation law for the time-continuous system (since exact discretization of a non-linear system is generally difficult), and to then implement this “quasi-continuously”, i.e. simply to assume that the sampling time for which it is performed in the processor is sufficiently short.

In contrast to conventional exact linearization (or more generally a conventional flatness-based regulator design), in robust exact linearization, the system is not given the behavior of linear, decoupled integrator chains, but rather the behavior of the original system linearized around a selected working point. In the present case of a PMSM, moreover, it is suitable not to directly select the system linearized around a working point as the target system, but rather to also reduce the size of the inductances by a factor γ≥1 in the form L_{d}/γ and L_{q}/γ. By appropriately selecting this factor, a compromise can thus be specified between a rapid dynamic response of the regulated system on the one hand (large γ) and robustness against measurement noise on the other hand (small γ). This does not result in decoupling of the two current components or flux components such as in the case of conventional exact linearization-they continue to remain coupled in accordance with the natural behavior of a PMSM.

Feed-forward control of the linear system created then leads already to a linear and asymptotically stable sequence-error dynamic, wherein smaller inductances of the selected target system lead to a more rapid decay rate of the sequence error. In contrast to conventional flatness-based sequence regulation, however, the sequence errors of the two components of the flat output (i.e. of the two current components or flux components) are not decoupled, but rather the sequence-error dynamic corresponds to the dynamic of a linear PMSM.

A steady-state control deviation between the actual and the desired currents or concatenated fluxes is corrected, by virtue of a disturbance voltage being estimated and the input voltage being adjusted accordingly.

The disturbance estimation takes place using a time-delay approach, wherein, using the measurements available at the present time step k, the disturbance can be calculated directly in the preceding time step k−1, wherein low-pass filtering optionally takes place.

Either the concatenated fluxes or the currents in the stator are selected as state variables for the system model.

In the design of a regulation law for a PMSM, the inductances normally do not represent design parameters or tuning parameters, but rather are merely included in the regulation law as system parameters, e.g. in the context of feed-forward control. That is to say, the nominal or identified values are used for this. To set the regulator performance, it is not the system parameters that are varied but rather the proportional portion and the integral portion e.g. in a PI regulator.

The regulator design proposed in the application, by contrast, is given to the system the behavior of a linear target system through a special form of exact linearization. The linearized PMSM with greatly reduced, notional inductance values is used as the target system. The position of the eigenvalues of the target system is changed by these notional smaller inductance values. In the time-continuous perspective, the real parts of the eigenvalues of the system become more negative, with the result that the system settles more rapidly. At the same time, however, the imaginary parts of the eigenvalues remain largely unchanged and the regulation remains robust against measurement noise. That is to say, the fact that the inductances serve as design parameters or tuning parameters (or specifically the scaling factor γ) is due solely to the fact that our regulator design is based on the selection of a notional PMSM target system.

The proposed control method has the following advantages:

It combines the superior dynamic performance of a flatness-based sequence regulation with the non-aggressive steady-state behavior of a PI regulator.

The method is more robust than a PI regulator both with respect to parameter deviations and with respect to low sampling frequencies.

The invention proceeds from a non-linear model of a PMSM, which maps the non-linear connection between the currents and the concatenated fluxes. There is no separate consideration of the three phases such as in the prior art, since these are assumed to be symmetrical.

Robust exact linearization as proposed in the application creates a linear system behavior by means of the regulation, but consciously dispenses with the decoupling of the two current components or flux components that is otherwise customary in conventional exact linearization.

Conventional exact linearization produces a linear system consisting of decoupled integrator chains (or shift chains in the time-discrete case), which is referred to as the Brunovsky normal form in the literature. These integrator chains are then typically regulated separately, i.e. the components of the error dynamic are decoupled.

In the application, it is a question precisely of not carrying out such decoupling, since the regulator becomes very susceptible to measurement noise as a result of the decoupling. Instead of the decoupling, the invention gives the system the behavior of the linearized PMSM as a result of the regulation. To achieve a more rapid settling behavior, however, the inductances are drastically reduced by means of a scaling factor in this linear target system, which leads to a shift in the eigenvalues in the complex number plane. When viewed as a time-continuous system, the real parts of the eigenvalues become more negative, whereas the imaginary parts remain largely unchanged. When viewed in a time-discrete manner, the eigenvalues are shifted toward the origin of the complex number plane.

The disturbance estimator used in the application estimates the voltage error produced by deviations between the nominal (non-linear) system model and the actual system, and other disturbances affecting the system. For this purpose, the disturbance estimator does not require the intended currents but rather the measured currents, i.e. it does not work “open-loop”. By taking the estimated voltage errors into account in the activation of the PMSM, steady-state control deviations can be compensated or avoided.

The system model according to the invention takes the non-linear connection between stator currents and concatenated stator fluxes into account, which is why it is non-linear. The proposed regulation design can be carried out both using a system model that possesses the concatenated stator fluxes as state variables and also using one that possesses the stator currents as state variables. A design based on the representation with the concatenated fluxes is advantageous, however, since the equations are simplified.

Further areas of applicability will become apparent from the description provided herein. The description and specific examples in this summary are intended for purposes of illustration only and are not intended to limit the scope of the present disclosure.

### BRIEF DESCRIPTION OF THE DRAWING

The drawing described herein is for illustrative purposes only of selected embodiments and not all possible implementations, and is not intended to limit the scope of the present disclosure, in which:

The FIGURE illustrates the proposed control method.

### DETAILED DESCRIPTION

Using a regulator for the robust exact linearization 1, the regulated non-linear PMSM 4 behaves like a linear system 2.

The linear (time-discrete) system 2 is described by Δxₖ₊₁=AΔxₖ+BΔvₖ, wherein A and B represent the matrices of the selected linear target system with the state Δxₓ and the input Δvₖ. The meaning of the reference signs is listed in the table below.

| Symbol | Description |
|---|---|
| z⁻¹ | Time delay |
| Δx_{ref, k+1} | Intended trajectory linear system |
| Δvₖ | Input variable linear system |
| u_{c, k} | Manipulated variable regulator for robust linearization |
| êₖ | Estimated disturbance voltage |
| uₖ | Input of the non-linear system |
| xₖ | State variable of the non-linear system |
| ωₑₗ | Electrical angular velocity |

The application of feed-forward control 3 of the form Δv_{ref,k}=B⁻¹(Δx_{ref,k+1}−AΔx_{ref,k}) for the linear system 2 on the basis of the desired intended trajectory Δx_{ref} leads to a linear sequence-error dynamic Δxₖ₊₁−Δx_{ref,k+1}=A(Δxₖ−Δx_{ref,k}) that is determined by the dynamic matrix A of the linear system.

To avoid steady-state control deviations, e.g. as a result of parameter deviations, the regulation concept is supplemented by a disturbance estimator 5. The individual blocks are described in detail below.

### Non-Linear System 4

The system equations of a non-linear PMSM 4 in rotor-fixed d/q coordinates can be written in a state representation

$$\dot{x} = f ( x , u )$$

with a two-dimensional state x that is selected as follows:

$$x = {[ {Ψ}_{d} {Ψ}_{q} ]}^{T}$$

(concatenated stator fluxes).

The input is given by the stator voltages in rotor-fixed d/q coordinates:

$$u = {[ {u}_{d} {u}_{q} ]}^{T} .$$

With the concatenated fluxes as the selected state variables, the non-linear system equations read

$$\frac{d {Ψ}_{d}}{d t} = {u}_{d} - R {i}_{d} ( {Ψ}_{d} , {Ψ}_{q} ) + {ω}_{e l} {Ψ}_{q}$$

$$\frac{d {Ψ}_{q}}{d t} = {u}_{q} - R {i}_{q} ( {Ψ}_{d} , {Ψ}_{q} ) - {ω}_{e l} {Ψ}_{d}$$

with R as the ohmic resistance and wet as the electrical angular velocity.

The proposed regulation method is based on a time-discrete system representation

$${x}_{k + 1} = f ( {x}_{k} , {u}_{k} ) ,$$

which can be obtained from the time-continuous system \dot{x}=f(x,u) by a suitable discretization method such as simple Euler discretization, for example, or else more sophisticated methods. The more accurate the discretization method, the better the achievable regulation performance.

### Regulator for Robust Exact Linearization

The basic idea of the robust exact linearization 1 consists in applying a non-linear regulation law of the form u=φ(x,Δv) in such a way that the regulated non-linear system \dot{x}=f(x,u) acquires a linear behavior

$$Δ \dot{x} = A Δ x + B Δ v ,$$

wherein A and B are the matrices of the linearization of the system around a selected steady-state point (xₛ,uₛ), i.e. f(xₛ,uₛ)=0 and Δx=x−xₛ.

That is to say, the regulator only removes the non-linearities of the system and therefore applies a very moderate, minimally aggressive control action. Decoupling into independent integrator chains, such as in the case of conventional exact linearization or a conventional flatness-based regulator design, is dispensed with. This leads to very good robustness properties with respect to measurement noise or parameter deviations.

For the above time-continuous non-linear PMSM model with the concatenated stator fluxes as state variables, linearization is produced around a steady-state point (Ψ_{d,s}, Ψ_{q,s}, u_{d,s}, u_{q,s}) with the approximation

$$\frac{\partial {Ψ}_{d}}{\partial {i}_{q}} = \frac{\partial {Ψ}_{q}}{\partial {i}_{d}} = 0$$

and the inductances

$${{{L}_{d} = \frac{\partial {Ψ}_{d}}{\partial {i}_{d}} \vert}_{{i}_{d , s} , {i}_{q , s}} and {L}_{q} = \frac{\partial {Ψ}_{q}}{\partial {i}_{q}} \vert}_{{i}_{d , s} {i}_{q , s}}$$

the system equations

$$\frac{d Δ {Ψ}_{d}}{d t} = - \frac{R}{{L}_{d}} Δ {Ψ}_{d} + {ω}_{e l} Δ {Ψ}_{q} + Δ {u}_{d}$$

$$\frac{d Δ {Ψ}_{q}}{d t} = - \frac{R}{{L}_{q}} Δ {Ψ}_{q} - {ω}_{e l} Δ {Ψ}_{d} + Δ {u}_{q} .$$

In a PMSM in which the system dynamic is very rapid in comparison with the typical sampling frequencies of the regulating circuit, moreover it has proven to be advantageous to apply the robust exact linearization 1 to a discretized model that takes the sampling time into account. For this purpose, a suitable discretization is carried out both for the non-linear system 4 and for the linear target system \dot{Δ}x=AΔx+BΔv. This therefore produces a linear, time-discrete system of the form Δxₖ₊₁=AΔxₖ+BΔvₖ as the target system, wherein it should be noted that the matrices A and B generally differ from those of the underlying time-continuous system. Equating

xₖ₊₁=xₛ+Δxₖ₊₁=xₛ+AΔxₖ+BΔvₖ=xₛ+A(xₖ−xₛ)+BΔv_{K}

with the right-hand side of the discretized non-linear system xₖ₊₁=f(xₖ,uₖ) then produces a series of equations

$$f ( {x}_{k} , {u}_{k} ) = {x}_{s} + A ( {x}_{k} - {x}_{s} ) + B Δ {v}_{k} ,$$

from which, by resolving for uₖ, a regulation law of the form uₖ=φ(xₖ,Δvₖ) is obtained, which converts the non-linear system into the desired linear system 2.

To achieve a more rapid dynamic behavior, it is advantageous to select precisely not the linearized PMSM as the linear target system, but rather a PMSM with significantly smaller inductances L_{d}/γ and L_{q}/γ. The quotient γ≥1 between the real and the selected “virtual” inductances allows for adjustment of the regulator with regard to the compromise between a rapid dynamic response on the one hand (large γ) and robustness against the measurement noise on the other hand (small γ). The linear target system with the adjustment parameter γ makes optimal setting possible. Therefore, decoupling, which is unfavorable in terms of robustness, is nevertheless avoided, however.

### Feed-Forward Control

From a desired intended trajectory x_{ref}(k), k≥0 for the state variables of the non-linear system, an intended trajectory for the state variables of the linear system 2 is produced directly with Δx_{ref}(k)=x_{ref}(k)−xₛ. Since the 2×2 matrix B is always invertible in the case of a PMSM, feed-forward control 3 for the linear system 2 from the system equations

$$Δ {x}_{k + 1} = A Δ {x}_{k} + B Δ {v}_{k}$$

thereof can be calculated immediately:

$$Δ {v}_{r e f} ( k ) = {B}^{- 1} ( Δ {x}_{r e f} ( k + 1 ) - A Δ {x}_{r e f} ( k ) )$$

This feed-forward control produces a linear sequence-error dynamic

$$Δ {x}_{k + 1} - Δ {x}_{r e f , k + 1} = A ( Δ {x}_{k} - Δ {x}_{r e f , k} ) .$$

The decay rate of the sequence error Δxₖ−Δx_{ref,k} is therefore determined by the dynamic matrix A of the selected linear target PMSM. Selecting smaller inductances for the linear target PMSM influences the position of the eigenvalues of the matrix A and leads to a more rapid decay rate of the sequence error.

### Disturbance Estimator 5

If the nominal system parameters of the non-linear PMSM do not coincide with the actual ones or other disturbances affect the system, with the above regulation law a steady-state control deviation would remain between the actual and the desired currents or concatenated fluxes. The reason for this is that the regulation law, in contrast to a PI regulator for example, does not have an integral portion. To take such disturbances into account, the system model

$${x}_{k + 1} = f ( {x}_{k} , {u}_{k} )$$

is expanded by disturbance voltages

$${e}_{k} = {[ \begin{matrix}{e}_{d , k} & {e}_{q , k}\end{matrix} ]}^{T}$$

in the form

$${x}_{k + 1} = f ( {x}_{k} , {u}_{k} - {e}_{k} ) .$$

That is to say, the disturbance ex acts on the system in the same way as the input voltage uₖ (here optionally with reversed sign). The purpose of a disturbance estimator 5 now consists in ascertaining an estimated value ex for the disturbance eₖ, so that it can then be compensated. If the voltage calculated by the above regulation law is denoted by u_{c,k}, instead of only using uₖ=u_{c,k}, uₖ=u_{c,k}+êₓ is applied.

A simple and efficient method for ascertaining an estimation êₖ is the so-called time-delay approach. Using the measurements available at the present time step k, the disturbance can be calculated directly in the preceding time step k−1, by virtue of the following equations for eₖ₋₁ being solved:

$${x}_{k} = f ( {x}_{k - 1} , {u}_{k - 1} - {e}_{k - 1} ) .$$

However, the direct use of this earlier value as an estimation êₖ=eₖ₋₁ would be problematic because of the measurement noise on the one hand and the time delay on the other hand. It is better to use a low-pass-filtered version that can be obtained, for example, by an update law of the following form:

$${\hat{e}}_{k} = {\hat{e}}_{k - 1} + α ( {e}_{k - 1} - {\hat{e}}_{k - 1} )$$

The parameter α∈(0,1] makes it possible to adapt the disturbance estimator with a view to a compromise between a rapid response to changing disturbances (a close to 1) and robustness against measurement noise (a close to 0).

The proposed regulation design is able to be realized in an identical manner with the currents as state variables:

$$x = {[ \begin{matrix}{i}_{d} & {i}_{q}\end{matrix} ]}^{T}$$

The invention optimizes the regulation and control of a PMSM using the concept of robust exact linearization and combining it with a disturbance estimator.

In addition, the regulation design is effected on the basis of a discretized machine model, in order to take the sampling time of the regulating circuit into account.

The linearized PMSM itself does not necessarily serve as the linear target system, but rather a linear PMSM with appropriately selected smaller inductances, in order to achieve a rapid dynamic without a further regulator.

1. A regulation system having a regulator,
wherein the system provides regulation of a stator current or a concatenated stator flux for operating a permanent-magnet synchronous machine, represents a non-linear system, and has at least one control unit that contains software modules,
wherein the regulator performs fer robust exact linearization for creating a linear system, feed-forward control, and a disturbance estimator.

2. A method for regulating the stator current or the concatenated stator flux for operating a permanent-magnet synchronous machine having regulation as claimed in claim 1, wherein the robust exact linearization of a PMSM by a non-linear regulation law is performed such that the regulated non-linear system acquires the behavior of a linear PMSM.

3. The method for regulation as claimed in claim 2, wherein the robust exact linearization is applied to a time-discretized model that takes a sampling time into account in order to arrive at a linear, time-discrete system.

4. The method for regulation as claimed in claim 2, wherein the linear target system does not correspond precisely to the linearized PMSM, but rather a target system with smaller inductances (L_{d}/γ and L_{q}/γ) is selected, wherein a quotient (γ≥1) for adjustment between a rapid dynamic response (large γ) and robustness against measurement noise (small γ) is specified.

5. The method for regulation as claimed in claim 2, wherein the feed-forward control of the linear system created leads to a linear sequence-error dynamic, wherein smaller inductances of the selected linear target system produce a more rapid decay rate of the sequence error.

6. The method for regulation as claimed in claim 2, wherein a steady-state control deviation between the actual and the desired currents or concatenated fluxes is corrected, by virtue of a disturbance voltage (eₖ=[e_{d,k} e_{q,k}]]) being estimated and the input voltage (uₖ) being adapted accordingly.

7. The method for regulation as claimed in claim 2, wherein the disturbance estimation takes place using a time-delay approach, wherein, using the measurements available at the present time step (k), the disturbance can be calculated directly in the preceding time step (k−1),
wherein low-pass filtering optionally takes place.

8. The method for regulation as claimed in claim 2, wherein either the concatenated stator fluxes or the stator currents (each in the rotor-fixed d/q coordinate system) are selected as state variables for the system model.

9. A method for regulating a stator current or a concatenated stator flux for operating a permanent-magnet synchronous machine having regulation,
wherein the regulation represents a non-linear system, having at least one control unit that contains software modules,
performing robust exact linearization by a regulator for creating a linear system, feed-forward control, and a disturbance estimator.

10. The method as claimed in claim 9,
wherein the robust exact linearization of a PMSM by a non-linear regulation law is performed such that the regulated non-linear system acquires the behavior of a linear PMSM.

11. The method as claimed in claim 10,
wherein the robust exact linearization is applied to a time-discretized model that takes a sampling time into account in order to arrive at a linear, time-discrete system.

12. The method as claimed in claim 11,
wherein the linear target system does not correspond precisely to the linearized PMSM, but rather a target system with smaller inductances (L_{d}/γ and L_{q}/γ) is selected, wherein a quotient (γ≥1) for adjustment between a rapid dynamic response (large γ) and robustness against measurement noise (small γ) is specified.

13. The method as claimed in claim 12,
wherein the feed-forward control of the linear system created leads to a linear sequence-error dynamic, wherein smaller inductances of the selected linear target system produce a more rapid decay rate of the sequence error.

14. The method as claimed in claim 13,
wherein a steady-state control deviation between the actual and the desired currents or concatenated fluxes is corrected, by virtue of a disturbance voltage (eₖ=[e_{d,k} e_{q,k}]]) being estimated and the input voltage (uₖ) being adapted accordingly.

15. The method as claimed in claim 14,
wherein the disturbance estimation takes place using a time-delay approach, wherein, using the measurements available at the present time step (k), the disturbance can be calculated directly in the preceding time step (k−1),
wherein low-pass filtering optionally takes place.

16. The method as claimed in claim 15,
wherein either the concatenated stator fluxes or the stator currents (each in the rotor-fixed d/q coordinate system) are selected as state variables for the system model.
